(19) United States
(12) Patent Application Publication
(10) Pub. No.: US 2009/0321995 A1
(43) Pub. Date: Dec. 31, 2009

(54) Method for making, positioning and securing dummy elements in models tested in wind tunnels

(76) Inventors: Jose Julian Alvarez Gonzalez, Madrid (ES); Eduardo Romero Checa, Madrid (ES)

Correspondence Address: WENDEROTH, LIND & PONACK, L.L.P., 1030 15th Street, N.W.,, Suite 400 East, Washington, DC, 20005-1503, US

(21) Appl. No.: 12/289,203

(22) Filed: Oct. 22, 2008

(30) Foreign Application Priority Data
Jun. 27, 2008 (ES) P200801940

(51) Int. Cl. B29C 35/04

(52) U.S. Cl. 264/401

(57) ABSTRACT

The dummy elements (1) are pieces which are backed on to the object to test for measurement of aerodynamic properties.

Once the geometry is known that the dummy element has to have on account of flight conditions, atmospheric conditions and the original aerodynamic surface, the shape of the dummy element (1) is reproduced by stereolithography, at the same time forming certain extensions (4) which follow the aerodynamic geometry of the object (3) and which are located in strategically selected positions, the whole acting by way of a negative template which is restricted to and follows the shapes of the leading edge. An adhesive is then applied to the surface of the dummy element (1) without it affecting the extensions (4) since they then have to be removed.

### OBJECT OF THE INVENTION

As stated in the title of this descriptive specification, the present invention relates to a procedure for positioning and securing of dummy elements for test models in a wind tunnel, the invention thus coming with the technical field of systems for measuring the aerodynamic properties of objects, and which are exposed to an airflow in a wind tunnel, and in the case of shapes of ice or other additions for analyzing the behavior.

One of the objects of the invention is to minimize the time needed for installing these dummy elements inside the tunnel so that they are perfectly fitted to the exact point of positioning on the aerodynamic surface to test.

### PRIOR ART OF THE INVENTION

In the design of the elements making up an aircraft, such as fuselage, wings, rudders, etc., one needs to know the aerodynamic properties of these components. In view of the large size of aircraft, aerodynamic tests are conducted with models which reproduce to scale all or at least part of the aircraft, and these models are tested in a wind tunnel.

In these tests, the aerodynamic behavior of the control surfaces of an airfoil (horizontal and vertical stabilizers, hypersustaining elements, etc.) need to be checked. It is of vital importance to verify the adverse effect of ice formation on this control surface and to confirm that it remains within the forecasted safety limits.

In the simulation of the dummy elements, tools are used for the generation of the external geometry according to the flight conditions, atmospheric conditions and the original aerodynamic surface. Once the geometry of the dummy element is known, it can be produced using rapid creation processes for prototypes, such as stereolithography, for being fitted to models and then be subjected to aerodynamic testing in a wind tunnel.

For an adequate simulation and evaluation of the aerodynamic effect, it is important to maintain a correct positioning of the dummy element with respect to the original surface. This positioning is usually carried out by means of one of the following methods:
Using various precision drill-holes on the aerodynamic surface and their corresponding fixings in the shape of ice.
Using grooves in the aerodynamic surface and their corresponding reliefs in the dummy element to couple.
Using positioning templates in negative form of part of the aerodynamic surface and of the dummy element.

The first two methods provide adequate positioning but these solutions imply an additional modification (drilling or cutting) of the aerodynamic surface in an area that is especially sensitive and which could compromise the measurements in the clean configuration (without any dummy elements).

The third method does not imply any extra modification of the aerodynamic surface, the dummy element pivots on the leading edge of the aerodynamic surface and is fixed when its negative form in the template is found, though it is difficult to obtain an exact positioning of the dummy element with this method and more time is taken in the fixing.

In general, all conventional methods imply spending a considerable amount of time in the installation inside the tunnel, they are complicated to manufacture and adjust and they do not permit an exact positioning. Given that the costs of operating wind tunnels are high, assembly alternatives need to be sought that would improve the accuracy of the positioning and facilitate the installation, thereby reducing the time taken.

### DESCRIPTION OF THE INVENTION

In general terms, the procedure for positioning and securing of dummy elements for test models in a wind tunnel, the object of the present invention, achieves the fixing of these without producing modifications in the surfaces of the model and therefore without altering its aerodynamic qualities.

This is achieved by means of exploiting the qualities of the rapid creation processes for prototypes, and more specifically stereolithography processes.

Stereolithography is a process of rapid production of prototypes which uses stratification for the construction of a design model. The technology uses liquid photopolymer resins which solidify on exposure to ultraviolet light. A computer program translates a CAD 3D model into “STL” electronic format used by stereolithographic machines, organizing the information into layers. An ultraviolet laser beam traces each section of the CAD model on to the surface of a photopolymer resin cube, thereby materializing the CAD for that zone, layer to layer.

By means of the stereolithographic process, at the same time as the geometry of the dummy element is being generated, it can be exploited in order to produce some extensions of the aerodynamic geometry in strategically selected positions in order to act in the manner of a negative template. These templates have a particular thickness and are joined to the shape of the dummy element defining at least two platforms using a minimum of material in order to maintain the appropriate rigidity and, once the dummy element has been fixed to the aerodynamic surface, to facilitate the subsequent elimination of those extensions or platforms.

The innovation introduced by this method which the invention proposes when manufacturing the dummy element and its template as an aerodynamic extension thereof in a single piece, by means of stereolithography:
On the one hand, when coupled to the leading edge of the aerodynamic surface or to the desired point thereof, provides a secure and adequate positioning.
On the other hand, this adequate adjustment is obtained without having to alter in any way the aerodynamic surface with fixings or grooves.
Finally, the simplicity of this method in the installation of dummy elements on models in wind tunnels provides a considerable reduction in the installation time.

Once the geometry has been obtained of the dummy element with its extensions, the latter having an adequate rigidity for efficiently performing its task, adhesive will be applied to the surface of the dummy element which has to remain in contact with the original surface of the model without this adhesive affecting the extensions. Once the setting time of the adhesive has passed, the extensions are removed by breaking them off or cutting them in the zone where they arise.

In order to facilitate an understanding of the characteristics of the invention and forming an integral part of this descriptive specification, some sheets of plans are attached containing figures in which, by way of illustration and non-limiting, the following has been represented:

### BRIEF DESCRIPTION OF THE DRAWINGS

FIG. 1. Is a schematic view in elevation of a typical shape of ice on the leading edge of a model of horizontal stabilizer shown in part, fixed with the procedure for positioning and securing in accordance with the invention.

FIG. 2. Is a view in perspective of a shape of ice provided with two extensions on each of its longitudinal edges.

FIG. 3. Is a view in perspective of a horizontal stabilizer of a model of aircraft, including a series of shapes of ice with extensions, which have to be fixed to the leading edge of the horizontal stabilizer and which are represented in exploded view.

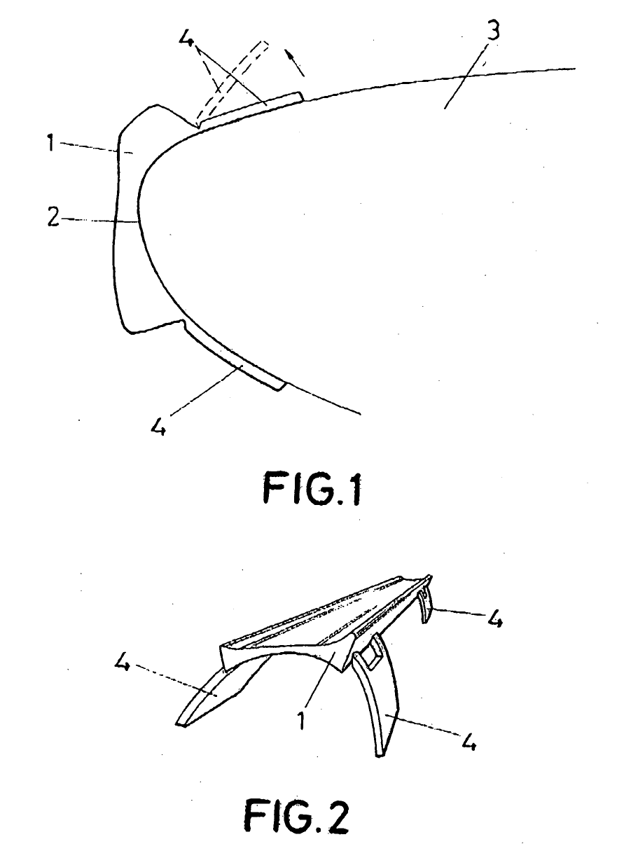

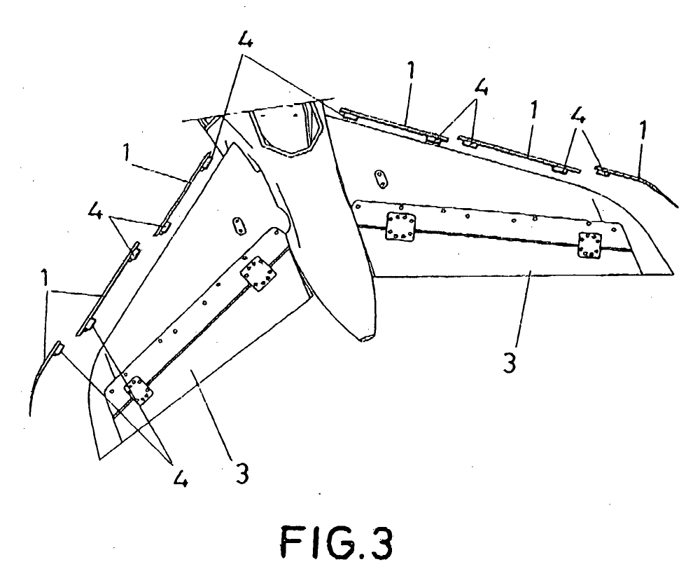

### DESCRIPTION OF THE PREFERRED FORM OF EMBODIMENT

Making reference to the numbering adopted in the figures, we can see how the procedure for positioning and securing of dummy elements for test models in a wind tunnel, which the invention proposes, starts from obtaining the geometric shape of the dummy element, in this example a previously defined shape of ice 1, in relation to the geometry presented by the leading edge 2 of the original aerodynamic surface of the object, in this case the horizontal stabilizer 3 of an aircraft.

In accordance with the invention, in the same process as that for obtaining the shape of ice 1, by means of the conventional stereolithographic procedure, some extensions 4 by way of a template are formed which perfectly follow the geometry of the aerodynamic surface of the model of the stabilizer in which it has to be positioned and fixed for the tests to which it has to be subjected.

With this arrangement, said shape of ice 1 with its extensions 4 are located with complete precision and easily and rapidly on the leading edge 2 of the aerodynamic surface, once a layer of adhesive has been applied solely to the contact surface of said shape of ice 1. When the adhesive has set, one can then proceed to cut or break the extensions via the initial zone, where a notch will preferably have been made in order to facilitate this.

1. METHOD FOR MAKING, POSITIONING AND SECURING DUMMY ELEMENTS IN MODELS TESTED IN WIND TUNNELS, for measurement aerodynamic properties of objects, particularly for checking the adverse effect generated on control surfaces of an airfoil so that it can be kept within the forecasted safety limits, comprising the following steps, once the geometry of the dummy element (1) is known,
the dummy element is made by stereolithography forming at the same time some extensions (4) by following the geometry of the surface of the object, in strategically selected positions and in the manner of a negative template, providing to the extensions (4) adequate rigidity for successfully fixing the position of the dummy element on the object.
gluing the dummy element to the object, applying adhesive between the surface of the dummy element (1) and the surface of the object which has to remain in contact without affecting the extensions (4), and
withdrawing the extensions (4) once the setting time of the adhesive has passed, by breaking or cutting in the zone where they arise.
